(19) United States
(12) Patent Application Publication
(10) Pub. No.: US 2025/0015304 A1
(43) Pub. Date: Jan. 9, 2025

(54) NEGATIVE ELECTRODE PLATE AND BATTERY

(71) Applicant: ZHUHAI COSMX BATTERY CO., LTD., Zhuhai (CN)

(72) Inventor: Chunyang LIU, Zhuhai (CN)

(73) Assignee: ZHUHAI COSMX BATTERY CO., LTD., Zhuhai (CN)

(21) Appl. No.: 18/898,302

(22) Filed: Sep. 26, 2024

Related U.S. Application Data
(63) Continuation of application No. PCT/CN2023/118586, filed on Sep. 13, 2023.

(30) Foreign Application Priority Data
Nov. 15, 2022 (CN) 202211427553.6

(51) Int. Cl. H01M 4/66; H01M 4/02; H01M 4/38; H01M 10/0525

(52) U.S. Cl. CPC H01M 4/667; H01M 4/382; H01M 4/663; H01M 4/666; H01M 10/0525; H01M 2004/027

(57) ABSTRACT

Disclosed are a negative electrode plate and a battery. The negative electrode plate includes a current collector and a coating layer disposed on at least one side surface of the current collector. The coating layer includes a silicon-containing material and a graphite material, and a median particle size Dv50 of the graphite material is smaller than a median particle size Dv50 of the silicon-containing material; and the silicon-containing material is a mixture of carbon and amorphous silicon, and a ray diffraction pattern of the silicon-containing material does not have an obvious diffraction peak of silicon, thereby improving an electric capacity of the negative electrode plate, decreasing the influence of volume expansion on a thickness of the electrode plate caused by lithium intercalation of the silicon-containing material, and reducing an expansion rate of the battery.

### CROSS-REFERENCE TO RELATED APPLICATIONS

The present disclosure is a continuation of International Application No. PCT/CN2023/118586, filed on Sep. 13, 2023, which claims priority to Chinese Patent Application 202211427553.6, filed on Nov. 15, 2022. All of the aforementioned patent applications are hereby incorporated by reference in their entireties.

### TECHNICAL FIELD

The present application relates to the field of battery technologies, and in particular, to a negative electrode plate and a battery and a battery.

### BACKGROUND

With the rapid development of lithium-ion batteries, lithium-ion batteries are widely used in various electronic products, requirements for fast charging of lithium-ion batteries are higher and higher, and energy densities of lithium-ion batteries of traditional graphite negative electrodes are difficult to meet requirements. Silicon negative electrode materials are considered to be next generation materials due to higher theoretical capacity thereof, and lithium-ion batteries including silicon negative electrode materials have been widely concerned.

At present, silicon negative electrode materials mainly include nano-silicon or silicon-oxygen. The silicon negative electrode materials are prone to expansion caused by lithium intercalation during a charge-discharge cycle, expansion of silicon caused by lithium intercalation usually occurs inside a crystal lattice. Even if silicon is made into nano-particles, volume change is still obvious with the increase of capacity. Although a large number of formula experiments and surface coating treatment of materials are carried out, it is still difficult to meet the requirements of reducing battery expansion.

### SUMMARY

The present disclosure provides a negative electrode plate and a battery, to solve a problem in a conventional technology that an expansion rate of a negative electrode plate of a battery is relatively high.

The present disclosure provides a negative electrode plate, including a current collector and a coating layer disposed on at least one side surface of the current collector, the coating layer includes a silicon-containing material and a graphite material, and a median particle size Dv50 of the graphite material is smaller than a median particle size Dv50 of the silicon-containing material. The silicon-containing material is a mixture of carbon and amorphous silicon, and/or a ray diffraction pattern of the silicon-containing material does not have an obvious diffraction peak of silicon.

The present disclosure further provides a battery, and the battery includes the foregoing negative electrode plate.

According to the present disclosure, the silicon-containing material is mixed with the graphite material, and a lithium intercalation potential of the silicon-containing material is higher than a lithium intercalation potential of the graphite material, so that the silicon-containing material is prior to the graphite material for lithium intercalation, which improves a lithium intercalation capability of the coating layer, thereby improving an electric capacity of the negative electrode plate. In addition, by using the graphite material with a small particle size, the median particle size Dv50 of the graphite material is smaller than the median particle size Dv50 of the silicon-containing material, which enlarges a gap between substances in the coating layer, thus decreasing the influence of volume expansion on a thickness of the electrode plate caused by lithium intercalation of the silicon-containing material, and reducing an expansion rate of the battery.

### BRIEF DESCRIPTION OF THE DRAWINGS

To describe the technical solutions in embodiments of the present application or in the conventional technology more clearly, the following briefly describes the accompanying drawings required for describing embodiments or the conventional technology. Apparently, the accompanying drawings in the following description show some embodiments of the present application, and a person of ordinary skill in the art may still derive other drawings from these accompanying drawings without creative efforts.

FIG. 1 is a scanning electron microscope (SEM) graph of a silicon-containing material and a graphite material provided by Example 1 of the present disclosure.

FIG. 2 is an SEM graph of a silicon-containing material and a graphite material provided by Comparative Example 1 of the present disclosure.

FIG. 3 is an XRD pattern of a silicon-containing material provided by an example of the present disclosure.

FIG. 4 is another scanning electron microscope (SEM) graph of the silicon-containing material and the graphite material provided by Example 1 of the present disclosure.

FIG. 5 is a comparison diagram of test data of Example 1 and Comparative Example 1 of the present disclosure.

FIG. 6 is a particle size distribution diagram of the silicon-containing material provided by the example of the present disclosure.

FIG. 7 is a particle size distribution diagram of the graphite material provided by the example of the present disclosure.

FIG. 8 is a particle size distribution diagram of mixing the silicon-containing material and the graphite material provided by the example of the present disclosure.

FIG. 9a shows Raman test data of the graphite material provided by the example of the present disclosure.

FIG. 9b shows Raman test data of the graphite material provided by the example of the present disclosure.

FIG. 10a shows Raman test data after mixing the silicon-containing material and the graphite material provided by the example of the present disclosure.

FIG. 10b shows Raman test data after mixing the silicon-containing material and the graphite material provided by the example of the present disclosure.

### DETAILED DESCRIPTION OF THE EMBODIMENTS

The following clearly describes the technical solutions in the embodiments of the present disclosure with reference to the accompanying drawings in the embodiments of the present disclosure. Apparently, the described embodiments are some but not all of the embodiments of the present disclosure. All other embodiments obtained by a person of ordinary skill in the art based on the embodiments of the present disclosure without creative efforts fall within the protection scope of the present disclosure.

The terms “first”, “second” and the like in the specification and claims of the present disclosure are used to distinguish between similar objects, but are not used to describe a specific order or chronological order. It should be understood that the structures used in this way are interchangeable under appropriate circumstances, so that the embodiments of the present disclosure can be implemented in an order other than those illustrated or described herein, and the objects distinguished by “first”, “second” and the like are generally used herein in a generic sense, and the number of objects is not limited, for example, a first object may be one or more than one.

The present disclosure provides a negative electrode plate, including a current collector and a coating layer disposed on at least one side surface of the current collector, the coating layer includes a silicon-containing material and a graphite material, and a median particle size Dv50 of the graphite material is smaller than a median particle size Dv50 of the silicon-containing material.

In an example, the silicon-containing material is a mixture of carbon and amorphous silicon, and/or a ray diffraction pattern of the silicon-containing material does not have an obvious diffraction peak of silicon.

In an example, a content of the silicon-containing material in the coating layer ranges from 1 wt % to 15 wt %.

In an example, a content of the silicon-containing material in the coating layer ranges from 35 wt % to 60 wt %.

In an example, a ray diffraction pattern of the silicon-containing material does not have an obvious diffraction peak of silicon.

In an example, in a Raman spectrum of the graphite material, a ratio between an intensity ID of a peak in a range of 1300 cm⁻¹ to 1400 cm⁻¹ to an intensity IG of a peak in a range of 1580 cm⁻¹ to 1620 cm⁻¹ is greater than or equal to 0.15.

In an example, in a Raman spectrum of the graphite material, a ratio between an intensity ID of a peak in a range of 1300 cm⁻¹ to 1400 cm⁻¹ to an intensity IG of a peak in a range of 1580 cm⁻¹ to 1620 cm⁻¹ ranges from 0.15 to 0.45.

In an example, the carbon material is an amorphous-carbon-coated graphite material.

In an example, the particle size Dv50 of the silicon-containing material ranges from 10 μm to 15 μm, and/or the particle size Dv50 of the graphite material ranges from 6 μm to 9 μm.

In an example, a specific surface area of the silicon-containing material ranges from 10 g/m² to 15 g/m².

In an example, a specific surface area of the graphite material ranges from 1.5 g/m² to 3 g/m².

In an example, a surface density of the coating layer in the current collector ranges from 3 mg/cm² to 15 mg/cm².

In an example, a press density of the coating layer ranges from 1.6 g/cm³ to 1.8 g/cm³.

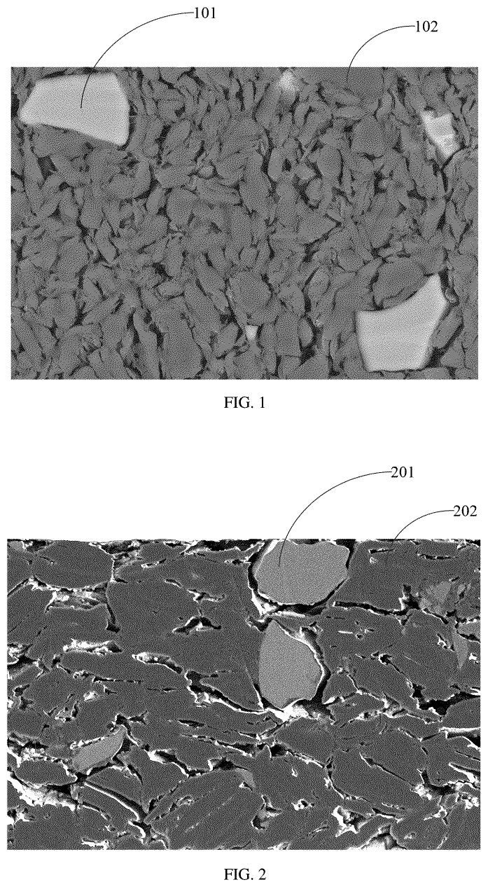

The present disclosure provides a negative electrode plat, including a current collector and a coating layer disposed on at least one side surface of the current collector. The coating layer includes a silicon-containing material 101 and a graphite material 102, and a median particle size Dv50 of the graphite material 102 is smaller than a median particle size Dv50 of the silicon-containing material 101, as shown in FIG. 1 and FIG. 4.

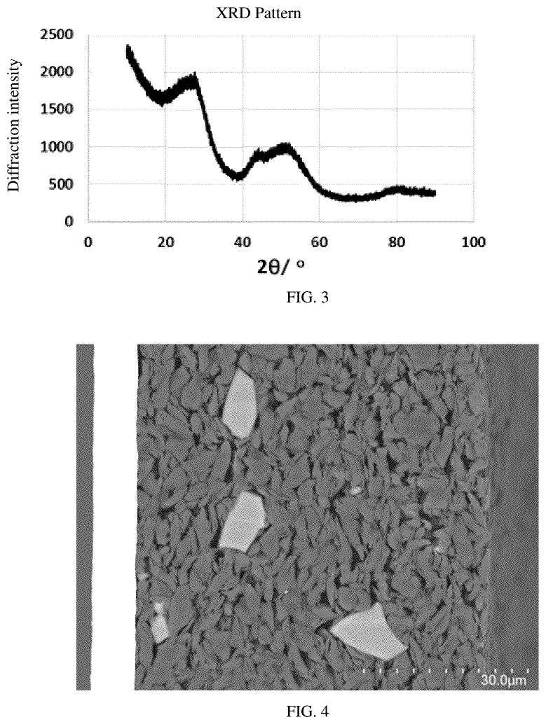

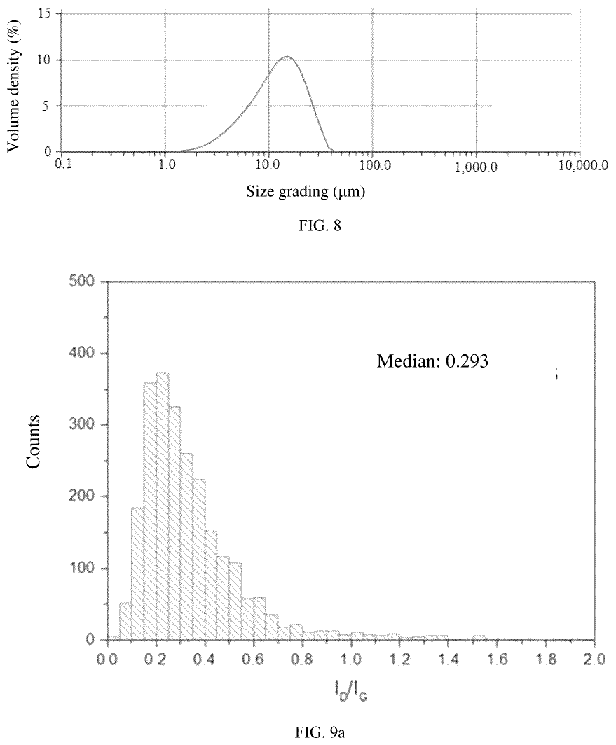

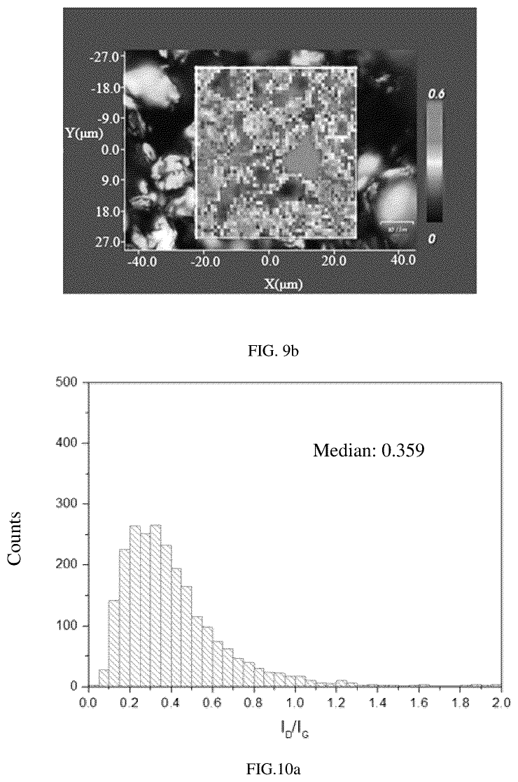

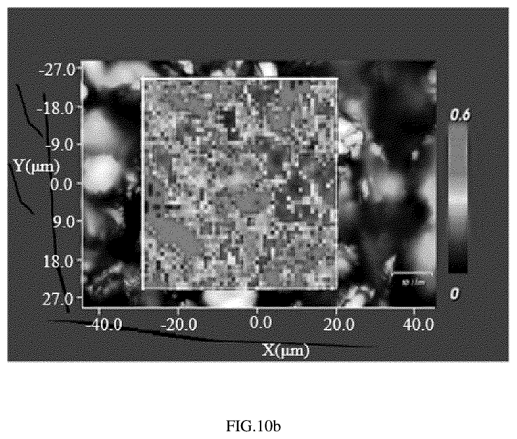

In an example the silicon-containing material 101 and the graphite material 102 are mixed, and a lithium intercalation potential of the silicon-containing material 101 is higher than a lithium intercalation potential of the graphite material 102, so that the silicon-containing material 101 is prior to the graphite material 102 for lithium intercalation, which improves a lithium intercalation capability of the coating layer, thereby improving an electric capacity of the negative electrode plate. In addition, by using the graphite material 102 with a small particle size, the median particle size Dv50 of the graphite material 102 is smaller than the median particle size Dv50 of the silicon-containing material 101, which enlarges a gap between substances in the coating layer, thus decreasing reducing the influence of volume expansion on a thickness of the electrode plate caused by lithium intercalation of the silicon-containing material 101, and reducing an expansion rate of the battery, as shown in FIG. 1, FIG. 3, FIG. 4, and FIG. 6, FIG. 7, FIG. 8, FIG. 9a, FIG. 9b, FIG. 10a, and FIG. 10b.

In an actual production process, particle sizes of the graphite materials may be different, and particle sizes of the silicon-containing materials may be different. In other words, the silicon-containing materials with different particle sizes and the graphite materials with different particle sizes may be selected, so that the particle size median Dv50 of the graphite material is smaller than the median particle size Dv50 of the silicon-containing material, and the same technical effects can be achieved.

It should be understood that expansion of silicon caused by lithium intercalation occurs inside a crystal lattice. Even though by way of formula or surface coating, or the silicon is made into nano-particles, volume change is still accompanied.

In an example, the silicon-containing material 101 may be a mixture of carbon and amorphous silicon. By designing a structure of the silicon-containing material 101, expansion of the silicon particles thereof is reduced, a contact between the silicon-containing material 101 and an electrolyte solution is decreased, and a side reaction is reduced. In addition, the graphite material 102 with a small particle size is used, so that the median particle size Dv50 of the graphite material 102 is smaller than the median particle size Dv50 of the silicon-containing material 101, and the gap between the substances in the coating layer is enlarged, so that the influence of the expansion of the silicon particles on the electrode plate structure is reduced while the rapid charging is realized through the matching design of the silicon-containing material 101 and the graphite material 102, so that the expansion rate of the battery is reduced.

The ray diffraction pattern of the silicon-containing material 101 does not have an obvious diffraction peak of silicon. In the X-ray diffraction (XRD) pattern, the silicon in the silicon-containing material 101 may be amorphous silicon, which has no obvious diffraction peak of silicon, and may further reduce the volume expansion of the silicon. In combination with the fact that the lithium intercalation potential of the silicon-containing material 101 may be higher than the lithium intercalation potential of the graphite material 102, the silicon-containing material 101 is prior to the graphite material 102 for lithium intercalation, and meanwhile, the volume expansion of the silicon-containing material 101 is reduced, for example, as shown in FIG. 3.

In the Raman spectrum of the graphite material 102, the ratio between the intensity ID of the peak in the range of 1300 cm⁻¹ to 1400 cm⁻¹ to the intensity IG of the peak in the range of 1580 cm⁻¹ to 1620 cm⁻¹ is greater than 0.15. In other words, a ratio of radiation intensities of a D peak to a G peak is greater than 0.15, as shown in FIG. 9a and FIG. 9b.

Both the D peak and the G peak may be Raman characteristic peaks of a carbon atom crystal, where the D peak represents a defect of the carbon atom crystal, the G peak represents in-plane telescopic vibration of sp2 hybridization of a carbon atom, and I may refer to intensity. ID/IG may be an intensity ratio of the D peak to the G peak, which may be used to describe an intensity relationship of the two peaks. The ratio of the intensity ID of the peak in the range of 1300 cm⁻¹ to 1400 cm⁻¹ to the intensity IG of the peak in the range of 1580 cm⁻¹ to 1620 cm⁻¹ is greater than 0.15, that is, the ratio of the radiation intensities of the D peak and the G peak is greater than 0.15. In other words, the value of ID/IG value is greater than 0.15. Preferably, 0.15<the value of ID/IG<0.45 (for example, 0.16, 0.18, 0.2, 0.25, 0.3, 0.35, 0.4, or 0.44), which improves the fast charging performance of the negative electrode plate. In addition, the graphite material 102 may be an amorphous-carbon-coated graphite material with a small particle size, so that the median particle size Dv50 of the graphite material 102 is smaller than the median particle size Dv50 of the silicon-containing material 101, which enlarges the gap between the substances in the coating layer, thereby decreasing the influence on the thickness of the electrode plate due to the volume expansion of the silicon-containing material 101 caused by lithium intercalation, and reducing the expansion rate of the battery.

In some examples, in the Raman spectrum of the mixture of the silicon-containing material and the graphite material, the ratio of the intensity ID of the peak in the range of 1300 cm⁻¹ to 1400 cm⁻¹ to the intensity IG of the peak in the range of 1580 cm⁻¹ to 1620 cm⁻¹ is greater than or equal to 0.15, that is, the ratio of the radiation intensities of the D peak and the G peak is greater than or equal to 0.15, that is, the value of ID/IG value is greater than or equal to 0.15. Preferably, 0.2≤the value of ID/IG≤0.6 (for example, 0.2, 0.25, 0.3, 0.35, 0.4, 0.45, 0.5, 0.55, or 0.6), which improves the fast charging performance of the negative electrode plate.

In an example, the particle size median Dv50 of the silicon-containing material 101 may range from 10 μm to 15 μm (for example, 10 μm, 11 μm, 12 μm, 13 μm, 14 μm, or 15 μm), and the median particle size Dv50 of the graphite material 102 may range from 6 μm to 9 μm (for example, 6 μm, 7 μm, 8 μm, or 9 μm). By using the amorphous-carbon coated graphite material with a small particle size, the median particle size Dv50 of the graphite material 102 is smaller than the median particle size Dv50 of the silicon-containing material 101, so as to form a reserved gap between the substances in the coating layer, and through the reserved gap, a situation that an overall thickness of the negative electrode plate is changed due to the expansion of silicon is slowed down. Moreover, the structure of the silicon-containing material 101 is further designed, so that the mixing arrangement of the carbon and the amorphous silicon reduces the expansion of the silicon particles thereof, thereby reducing the expansion rate of the battery. For example, the median particle size Dv50 of the silicon-containing material 101 is shown in FIG. 6, and the particle size median Dv50 of the graphite material 102 is shown in FIG. 7.

In an example, the content of the silicon-containing material 101 in the coating layer may range from 1 wt % to 15 wt %. For example, the content of the silicon-containing material 101 in the coating layer may be 1 wt %, 3 wt %, 5 wt %, 7 wt %, 10 wt %, 12 wt %, or 15 wt %, so as to give consideration to the energy density and the charging performance of the battery. In the whole charging process of the battery, since the lithium intercalation potential of the silicon-containing material 101 is greater than the lithium intercalation potential of the graphite material 102, the silicon completes lithium intercalation prior to the graphite, and only the graphite is embedded in the later period of charging. In this way, by disposing the silicon-containing material 101 in the coating layer, and setting the content of the silicon-containing material 101 in the coating layer to range from 1 wt % to 15 wt %, the fast charging performance of the battery is improved. In addition, a lithium precipitation problem is easier to occur during high current charging; therefore, adopting the amorphous-carbon-coated graphite material with a small particle size can reduce the lithium precipitation during the rapid charging of the battery.

A content of the amorphous silicon in the silicon-containing material 101 may range from 35 wt % to 60 wt % (for example, 35 wt %, 40 wt %, 45 wt %, 50 wt %, 55 wt %, or 60 wt %). The higher content of the amorphous silicon in the negative electrode plate is easy to reduce the energy density of the battery; while the lower content of the amorphous silicon in the negative electrode energy density is easy to lead to the decline of the fast charging performance. By balancing the content of the amorphous silicon, the performance of the battery can be improved and the expansion rate of the battery can be reduced.

In an example, the coating layer may be disposed on at least one side surface of the current collector by double-layer coating or single-layer coating, so that the surface density of the coating layer on the current collector ranges from 3 mg/cm² to 15 mg/cm² (for example, 3 mg/cm², 5 mg/cm², 7 mg/cm², 9 mg/cm², 11 mg/cm², 13 mg/cm², or 15 mg/cm²), and the press density of the coating layer ranges from 1.6 g/cm³ to 1.8 g/cm³ (for example, 1.6 g/cm³, 1.65 g/cm³, 1.7 g/cm³, 1.75 g/cm³, or 1.8 g/cm³) to improve the energy density of the battery; the content of the amorphous silicon in the silicon-containing material 101 may range from 35 wt % to 60 wt % to balance comprehensive performances of the battery; the specific surface area of the silicon-containing material 101 may range from 10 g/m² to 15 g/m² (for example, 10 g/m², 11 g/m², 12 g/m², 13 g/m², 14 g/m², or 15 g/m²), and the specific surface area of the graphite material 102 may range from 1.5 g/m² to 3 g/m² (for example, 1.5 g/m², 1.8 g/m², 2 g/m², 2.2 g/m², 2.5 g/m², 2.8 g/m², or 3 g/m²) In this way, the expansion of the silicon-doped negative electrode plate is effectively improved through various designs, and a cycle life of the battery is prolonged. The surface density of the coating layer on the current collector is a single-sided density, for example, when there is a coating layer on one side of the current collector, the surface density of the coating layer is a surface density of the side (that is, the side with the coating layer); when there are coating layers on both sides of the current collector, surface densities of the two sides of the current collector are the same, and the surface density of the coating layer is the surface density of any side of the current collector.

The present disclosure further provides a battery, including a positive electrode plate and the foregoing negative electrode plate.

It should be noted that the implementation of the foregoing negative electrode plate is also applicable to the embodiment of the battery and can achieve the same technical effect, and details are not described herein again.

In order to make the objectives, features and advantages of the present disclosure more obvious, the embodiments of the present disclosure will be described in detail. The content of the amorphous silicon in the silicon-containing materials 101 used in the embodiments are all 60 wt %. It should be noted that the content of the amorphous silicon in the silicon-containing materials 101 may range from 35 wt % to 60 wt %, for example, the contents of the amorphous silicon in the silicon-containing materials 101 are all 35 wt %, 40 wt %, 45 wt %, or 50 wt %, all of which can achieve the same technical effects. Here, it only takes the content of the amorphous silicon in the silicon-containing material 101 being 60 wt % as an example. The embodiments described in the present disclosure are merely some, but not all of the embodiments of the present disclosure. All other embodiments obtained by a person of ordinary skill in the art based on the embodiments of the present disclosure without creative efforts fall within the protection scope of the present disclosure. Unless otherwise specified, all reagents, materials, and instruments used in the following description are all conventional reagents, conventional materials, and conventional instruments, all of which are commercially available, and the involved reagents may also be obtained through synthesis by using conventional synthetic methods.

Negative electrode plate: the negative electrode plate includes a current collector and a coating layer disposed on at least one side surface of the current collector, the coating layer includes a silicon-containing material 101, a graphite material 102, a conductive agent and a binder, and may further contain a dispersing agent. The graphite material 102 is small-particle graphite, the raw materials of which may be common needle coke, ordinary petroleum coke or pitch coke, and the graphite material 102 may be a single particle, a secondary particle, and a mixture of single and secondary particles. The conductive agent, the dispersing agent, the binder and the negative electrode current collector used are commonly used materials in batteries, and are not specially limited.

Positive electrode plate: the positive electrode plate includes a positive electrode current collector and a positive electrode material, a conductive agent and a binder disposed on the positive electrode current collector. The positive electrode material may be at least one of lithium cobalt oxide, a nickel-cobalt-manganese ternary material, a nickel cobalt aluminum ternary material, lithium iron phosphate, lithium manganese oxide, lithium manganese iron phosphate, lithium nickel oxide, or lithium nickel manganese oxide. The conductive agent, the binder and the positive electrode current collector are commonly used materials in positive electrodes, and are not specially limited. The positive electrode material above includes a doped or coated positive electrode material thereof.

Separator: the separator is a common material for batteries to prevent short circuit between positive and negative electrodes, and all commercial separators may be used.

Electrolyte solution: electrolyte solution solvents and additives commonly used in lithium-ion batteries are adopted, and electrolyte solutions conducive to improving performances can be used in the battery of the present disclosure.

### Example 1

A silicon-containing material 101 with a median particle size Dv50 of 10 μm and a graphite material 102 with a median particle size Dv50 of 8 μm were mixed, and a content of the silicon-containing material 101 was 5 wt %. A conductive agent and sodium carboxymethyl cellulose as a dispersing agent, and a styrene-butadiene rubber as a binder were added to make a slurry, the slurry was coated on one side surface of a copper foil according to a surface density of 8 mg/cm², then dried, rolled according to a press density of 1.7 g/cm³, and cut and sliced according to a designed size to obtain a negative, for example, as shown in FIG. 1 and FIG. 4.

A separator, a positive electrode plate and the negative electrode plate made above were laminated and wound, followed by processing such as drying, liquid injection and formation to prepare a battery.

Meanwhile, Examples 2 to 8 were set. The preparation processes of the batteries in Examples 2 to 8 are all the same as that in Example 1, and the difference lies in the following Table 1.

TABLE 1

| | Proportion of | Median particle | Median particle | Value of | Press surface |
|---|---|---|---|---|---|
| | silicon- | size Dv50 of | size Dv50 | ID/IG of | density of |
| | containing | silicon- | of graphite | graphite | negative |
| | material 101 in | containing | material | material | electrode |
| | coating layer | material 101 | 102 | 102 | plate |
| Example | 5 wt % | 10 μm | 8 μm | 0.19 | 1.7 g/cm³ |
| 1 | | | | | |
| Example | 5 wt % | 12 μm | 8 μm | 0.19 | 1.7 g/cm³ |
| 2 | | | | | |
| Example | 5 wt % | 13 μm | 8 μm | 0.21 | 1.7 g/cm³ |
| 3 | | | | | |
| Example | 5 wt % | 15 μm | 8 μm | 0.21 | 1.7 g/cm³ |
| 4 | | | | | |
| Example | 15 wt % | 10 μm | 8 μm | 0.17 | 1.8 g/cm³ |
| 5 | | | | | |
| Example | 15 wt % | 12 μm | 8 μm | 0.17 | 1.8 g/cm³ |
| 6 | | | | | |
| Example | 15 wt % | 13 μm | 8 μm | 0.15 | 1.8 g/cm³ |
| 7 | | | | | |
| Example | 15 wt % | 15 μm | 8 μm | 0.15 | 1.8 g/cm³ |
| 8 | | | | | |

Comparative Example 1 to Comparative Example 3 were further set.

### Comparative Example 1

A silicon-containing material 201 with a median particle size Dv50 of 10 μm and a graphite material 202 with a median particle size Dv50 of 13 μm were mixed, and a content of the silicon-containing material 201 was 5 wt %. A conductive agent and sodium carboxymethyl cellulose as a dispersing agent, and a styrene-butadiene rubber as a binder were added to make a slurry, the slurry was coated on one side surface of a copper foil according to a surface density of 8 mg/cm², then dried, rolled according to a press density of 1.7 g/cm³, and cut and sliced according to a designed size to obtain a negative, for example, as shown in FIG. 2.

A separator, a positive electrode plate and the negative electrode plate made above were laminated and wound, followed by processing such as drying, liquid injection and formation to prepare a battery.

Meanwhile, Comparative Example 2 and Comparative Example 3 were set. The preparation processes of Comparative Example 2 and Comparative Example 3 are all the same as that in Example 1, and the difference lies in the following Table 2.

TABLE 2

| | Proportion of | Median particle | Median particle | Value of | Press surface |
|---|---|---|---|---|---|
| | silicon- | size Dv50 of | size Dv50 | ID/IG of | density of |
| | containing | silicon- | of graphite | graphite | negative |
| | material 201 in | containing | material | material | electrode |
| | coating layer | material 201 | 202 | 202 | plate |
| Comparative | 5 wt % | 10 μm | 13 μm | 0.09 | 1.7 g/cm³ |
| Example 1 | | | | | |
| Comparative | 5 wt % | 12 μm | 15 μm | 0.09 | 1.7 g/cm³ |
| Example 2 | | | | | |
| Comparative | 15 wt % | 15 μm | 17 μm | 0.07 | 1.8 g/cm³ |
| Example 3 | | | | | |

Items 1 to 4 were tested for Examples 1 to 8 and Comparative Example 1 to Comparative Example 3 respectively:

Item 1: Test of an expansion rate of an electrode plate: a battery was charged to fifty percent (50% SCO) charge state, and disassembled, and a ratio of a thickness of a negative electrode plate to a thickness of the negative electrode plate after roll-pressing was measured by using a ten-thousandth micrometer, and then recorded.

Item 2: Test of a cycling capacity retention rate test: the battery to was charged to full charge state at a rate of 2 C, and then discharged to 3.0 V at a rate of 0.7 C, which was recorded as a number of cycles. After 100 cycles, a ratio of a capacity of the battery to an initial capacity of the battery without cycling was tested and recorded.

Item 3: Test of a cycling expansion rate: the battery to was charged to full charge state at a rate of 2 C, and then discharged to 3.0 V at a rate of 0.7 C. After 100 cycles, a ratio of a thickness of the battery in the full charge state to a thickness of the battery in the initial 50% SCO state of charge was tested and recorded.

Item 4: Constant current charged ratio: the battery was charged to full charge state at a rate of 2 C, and then discharged to 3.0 V at a rate of 0.2 C, which was recorded as an initial capacity, and then charged at a rate of 2 C, and a ratio of the capacity of constant current charging to the initial capacity was tested and recorded.

Test results are shown in Table 3.

TABLE 3

| | Thickness | Battery capacity | Thickness | Constant |
|---|---|---|---|---|
| | expansion rate of | retention | expansion rate of | current charged |
| | 50% SOC negative | after 100 | battery after 100 | capacity ratio |
| | electrode plate | cycles at 2 C | cycles at 2 C | at 2 C |
| Example 1 | 50.2% | 50.2% | 50.2% | 50.2% |
| Example 2 | 50.2% | 50.2% | 50.2% | 50.2% |
| Example 3 | 50.2% | 50.2% | 50.2% | 50.2% |
| Example 4 | 50.2% | 50.2% | 50.2% | 50.2% |
| Example 5 | 50.2% | 50.2% | 50.2% | 50.2% |
| Example 6 | 50.2% | 50.2% | 50.2% | 50.2% |
| Example 7 | 50.2% | 50.2% | 50.2% | 50.2% |
| Example 8 | 50.2% | 50.2% | 50.2% | 50.2% |
| Comparative | 50.2% | 50.2% | 50.2% | 50.2% |
| Example 1 | | | | |
| Comparative | 50.2% | 50.2% | 50.2% | 50.2% |
| Example 2 | | | | |
| Comparative | 50.2% | 50.2% | 50.2% | 50.2% |
| Example 3 | | | | |

According to the test results of the above-mentioned Examples 1 to 8 and Comparative Examples 1 to 3, it may be learned that, by using the graphite material 102 with a small particle size, the median particle size Dv50 of the graphite material 102 is smaller than the median particle size Dv50 of the silicon-containing material 101. Moreover, the designing of mixing the silicon-containing material 101 and the graphite material 102 enables the prepared battery to have excellent cycling retention rate of the battery, and the expansion of the electrode plate and the expansion of the battery are both better than those of the electrode plate and the expansion of the battery prepared by mixing the graphite material 202 with a large particle size and the silicon-containing material 201.

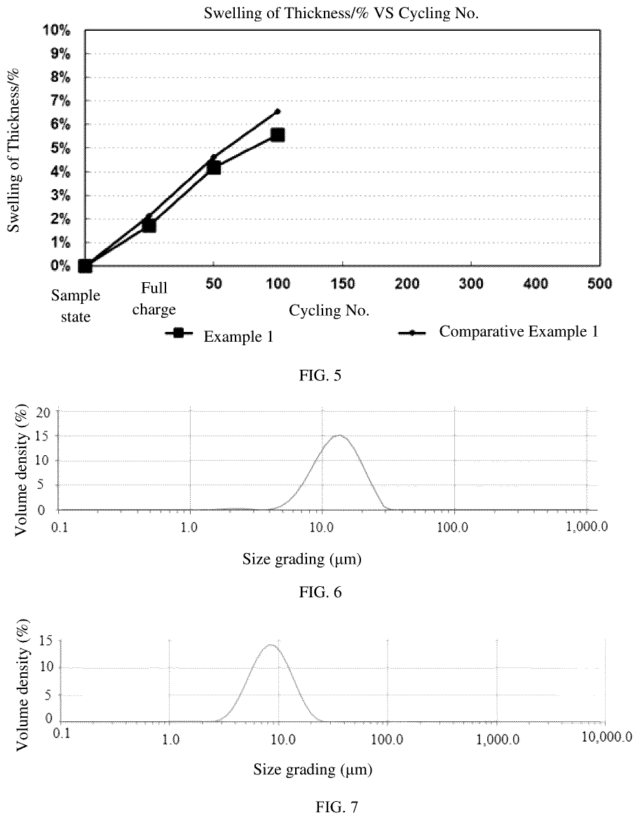

Moreover, the electrode plate adopting the graphite material 102 with the median particle size Dv50 smaller than the median particle size Dv50 of the silicon-containing material 101 forms a relatively uniform gap after one charge and discharge. However, the electrode plate adopting the graphite material 202 with the median particle size Dv50 smaller than the median particle size Dv50 of the silicon-containing material 201 has uneven gaps and large gaps around silicon particles and between graphite particles after one charge and discharge. This is caused by the expansion of charge and discharge of the silicon particles, which squeezes the graphite particles and shrinks the silicon particles when discharging. However, the graphite material 102 with a small median particle size Dv50 is less affected by expansion extrusion when charging and shrinkage when discharging The charging performance of the battery prepared by adopting the design that the median particle size Dv50 of the graphite material 102 is smaller than the median particle size Dv50 of the silicon-containing material 101 is also improved, which is more conducive to the application in fast charging batteries. For example, the above findings can be concluded by comparison between FIG. 1 and FIG. 2, and between FIG. 4 and FIG. 5.

It should be noted that, as used herein, terms “include”, “contain”, or any other variants thereof are intended to cover non-exclusive inclusion so that a process, method, article, or apparatus that includes a series of elements not only includes these very elements, but may also include other elements not expressly listed, or also include elements inherent to this process, method, article, or apparatus. Without being subject to further limitations, an element defined by a phrase “including . . . ” does not exclude presence of other identical elements in the process, method, article, or apparatus that includes the element. In addition, it should be pointed out that the scope of the method and apparatus in the implementation of the present disclosure is not limited to performing functions in the discussed order, and may further include performing functions in a substantially simultaneous manner or in a reverse order according to the functions involved. For example, the described method may be performed in a different order from that described, and various steps may be added, omitted, or combined. In addition, the features described with reference to some examples may be combined in other examples.

The embodiments of the present disclosure are described above with reference to the accompanying drawings, but the present disclosure is not limited to the foregoing specific implementations. The foregoing specific implementations are merely illustrative and nonrestrictive. Under the guidance of the present disclosure, a person of ordinary skill in the art can also make many forms without departing from the scope of protection of the present disclosure and the claims, all of which are within the protection of the present disclosure.

What is claimed is:

1. A negative electrode plate, comprising a current collector and a coating layer disposed on at least one side surface of the current collector, wherein the coating layer comprises a silicon-containing material and a graphite material, and a median particle size Dv50 of the graphite material is smaller than a median particle size Dv50 of the silicon-containing material; and
the silicon-containing material is a mixture of carbon and amorphous silicon, and a ray diffraction pattern of the silicon-containing material does not have an obvious diffraction peak of silicon.

2. The negative electrode plate according to claim 1, wherein a content of the silicon-containing material in the coating layer ranges from 1 wt % to 15 wt %.

3. The negative electrode plate according to claim 1, wherein a content of the amorphous silicon in the silicon-containing material ranges from 35 wt % to 60 wt %.

4. The negative electrode plate according to claim 1, wherein in a Raman spectrum of the graphite material, a ratio between an intensity ID of a peak in a range of 1300 cm⁻¹ to 1400 cm⁻¹ to an intensity IG of a peak in a range of 1580 cm⁻¹ to 1620 cm⁻¹ is greater than or equal to 0.15.

5. The negative electrode plate according to claim 1, wherein in a Raman spectrum of the graphite material, a ratio between an intensity ID of a peak in a range of 1300 cm⁻¹ to 1400 cm⁻¹ to an intensity IG of a peak in a range of 1580 cm⁻¹ to 1620 cm⁻¹ ranges from 0.15 to 0.45.

6. The negative electrode plate according to claim 1, wherein the carbon material is an amorphous-carbon-coated graphite material.

7. The negative electrode plate according to claim 1, wherein the particle size Dv50 of the silicon-containing material ranges from 10 μm to 15 μm, and/or the particle size Dv50 of the graphite material ranges from 6 μm to 9 μm.

8. The negative electrode plate according to claim 1, wherein a specific surface area of the silicon-containing material ranges from 10 m²/g to 15 m²/g; and/or
a specific surface area of the graphite material ranges from 1.5 g/m² to 3 g/m².

9. The negative electrode plate according to claim 1, wherein a surface density of the coating layer in the current collector ranges from 3 mg/cm² to 15 mg/cm²; and/or
a press density of the coating layer ranges from 1.6 g/cm³ to 1.8 g/cm³.

10. The negative electrode plate according to claim 1, wherein a lithium intercalation potential of the silicon-containing material is higher than a lithium intercalation potential of the graphite material.

11. The negative electrode plate according to claim 1, wherein in a Raman spectrum of a mixture of the silicon-containing material and the graphite material, a ratio between an intensity ID of a peak in a range of 1300 cm⁻¹ to 1400 cm⁻¹ to an intensity IG of a peak in a range of 1580 cm⁻¹ to 1620 cm⁻¹ is greater than or equal to 0.15.

12. The negative electrode plate according to claim 1, wherein in a Raman spectrum of a mixture of the silicon-containing material and the graphite material, a ratio between an intensity ID of a peak in a range of 1300 cm⁻¹ to 1400 cm⁻¹ to an intensity IG of a peak in a range of 1580 cm⁻¹ to 1620 cm⁻¹ ranges from 0.2 to 0.6.

13. A battery, comprising the negative electrode plate according to claim 1.
